(19) United States
(12) Patent Application Publication
(10) Pub. No.: US 2012/0217398 A1
(43) Pub. Date: Aug. 30, 2012

(54) ELECTRONIC DEVICE AND INFRARED RECEIVING DEVICE THEREOF

(75) Inventors: XIAO-HUI ZHOU, Shenzhen City (CN); MIN-LI LI, Shenzhen City (CN); HONG LI, Shenzhen City (CN); TING-TING ZHAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/154,443

(22) Filed: Jun. 7, 2011

(30) Foreign Application Priority Data
Feb. 25, 2011 (CN) 201110045672.0

(51) Int. Cl. G01J 5/10

(52) U.S. Cl. 250/338.1

(57) ABSTRACT

An exemplary infrared receiving device is adapted for mounting on a printed circuit board. The infrared receiving device includes an infrared receiver and a supporting seat configured to be mounted on the printed circuit board. The infrared receiver is attached to the supporting seat with the supporting seat supporting and protecting the infrared receiver. An electronic device includes a main body, a flip cover pivotably attached to the main body, and a display screen embedded in the flip cover. The main body includes a printed circuit board, an infrared receiver mounted on the printed circuit board, and a supporting seat mounted on the printed circuit board. The supporting seat holds the infrared receiver to support and protect the infrared receiver.

### BACKGROUND

1. Technical Field

The disclosure relates to electronic devices, and particularly to an electronic device including an infrared (IR) receiving device for receiving an IR signal.

2. Description of Related Art

Some electronic devices such as Digital Video Disc (DVD) players include an IR receiving device for receiving IR signals. The IR receiving device generally includes a head and three long pins extending from the head to connect with a printed circuit board. The IR receiving device is prone to be damaged because the pins are long and thin.

What is needed, therefore, is an electronic device which can overcome the above-described problems.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the various views.

FIG. 1 is a schematic, assembled view of an electronic device in accordance with an embodiment of the disclosure.

FIG. 2 is a schematic, enlarged, assembled view of an infrared receiving device and part of a printed circuit board of the electronic device of FIG. 1.

FIG. 3 is an exploded view of the infrared receiving device and the printed circuit board of FIG. 2.

FIG. 4 is a view similar to FIG. 3, but shown from a different aspect.

FIG. 5 is an inverted view of a supporting seat of the infrared receiving device of FIG. 4.

FIG. 6 is a cross section view of the infrared receiving device and the printed circuit board of FIG. 2, taken along line VI-VI thereof.

FIG. 7 is a cross section view of the infrared receiving device and the printed circuit board of FIG. 2, taken along line VII-VII thereof.

FIG. 8 is a cross section view of the infrared receiving device and the printed circuit board of FIG. 2, taken along line VIII-VIII thereof.

### DETAILED DESCRIPTION

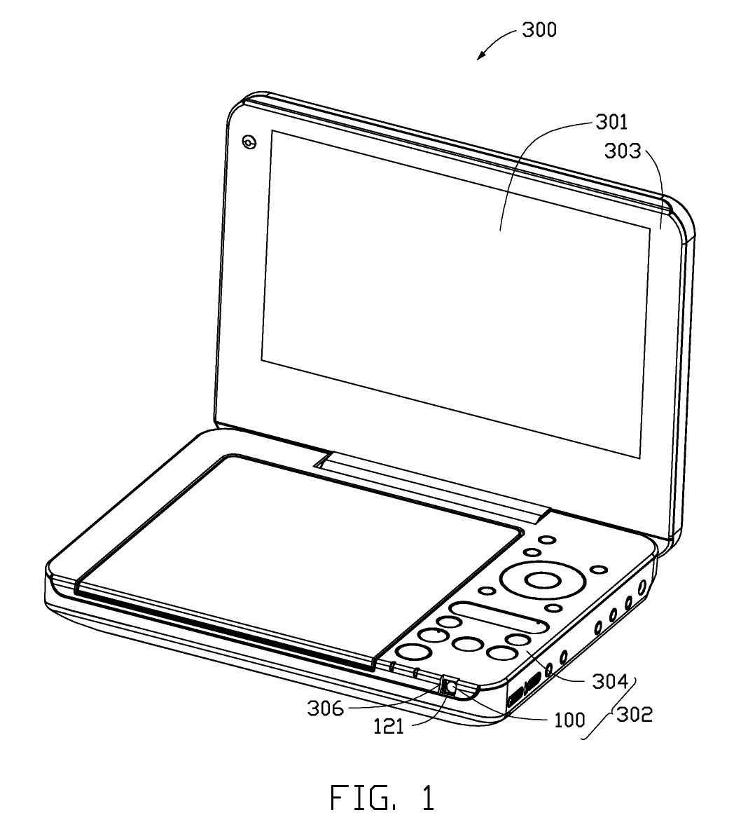

Referring to FIG. 1, an electronic device 300 in accordance with an embodiment of the disclosure is illustrated. The electronic device 300 includes a main body 302, a flip cover 303 pivotably attached to the main body 302, and a display screen 301 embedded in the flip cover 303. The main body 302 includes a housing 304 and an infrared (IR) receiving device 100 mounted in the housing 304. The housing 304 defines an opening 306 in a front side thereof. The flip cover 303 is pivotably attached to a rear side of the housing 304. The infrared (IR) receiving device 100 receives infrared (IR) signals.

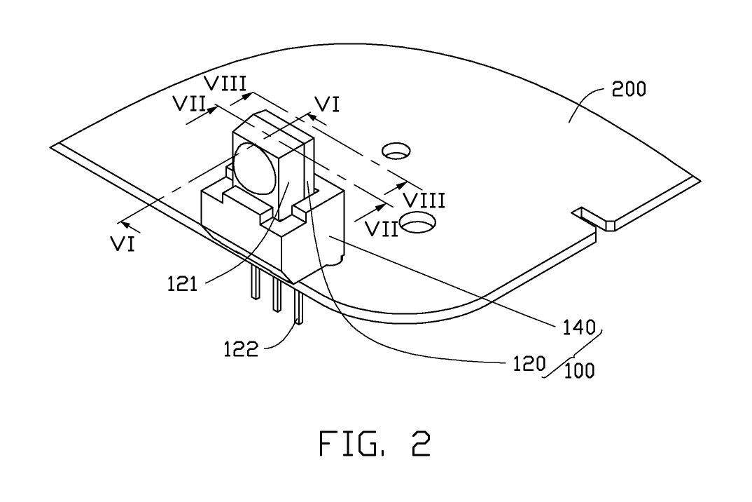

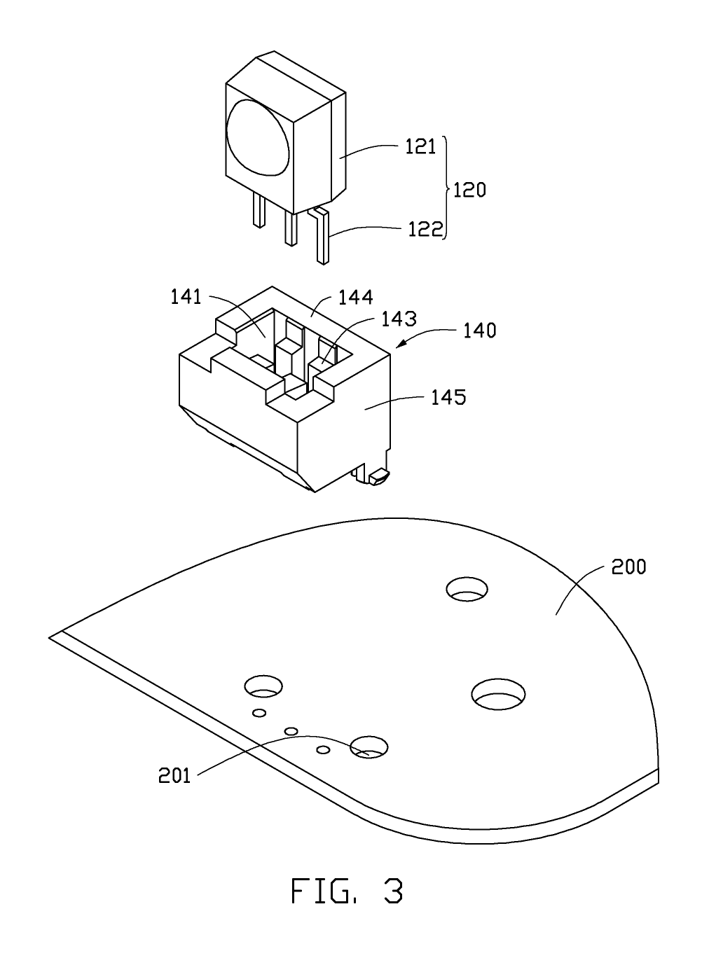

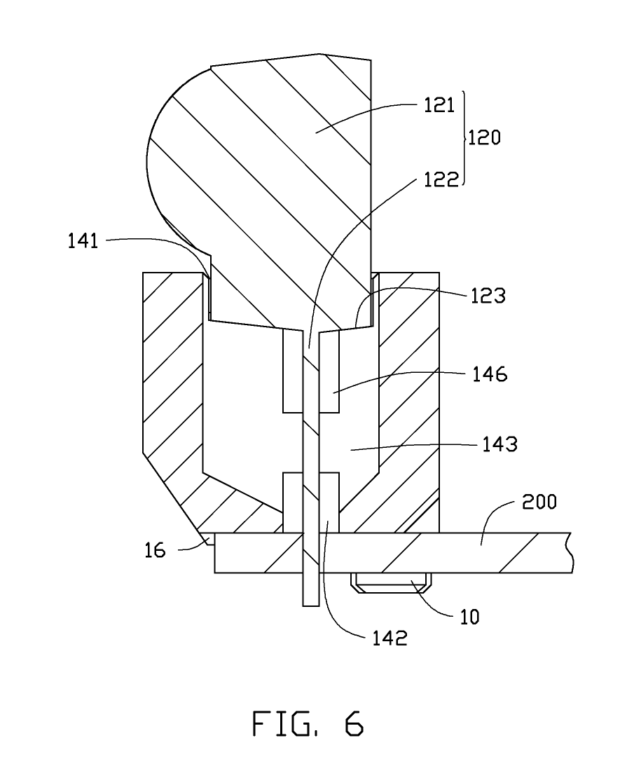

Referring also to FIGS. 2-3, the IR receiving device 100 includes an infrared (IR) receiver 120, and a supporting seat 140 mounted on a printed circuit board 200 to hold, support and protect the infrared receiver 120. The infrared receiver 120 includes a head 121, and a plurality of pins 122 extending outwardly from a bottom 123 of the head 121 (see FIG. 6). The opening 306 of the housing 304 exposes the head 121 of the infrared receiver 120. A bottom portion of the head 121 is embedded in the supporting seat 140. The pins 122 extend through the supporting seat 140 and are electrically connected with the printed circuit board 200.

In this embodiment, the infrared receiver 120 has three pins 122, wherein one of the pins 122 is a grounded pin for preventing static electricity or leakage electricity from damaging the infrared receiver 120; another one of the pins 122 is a voltage-output pin for outputting signals of the infrared receiver 120 to the printed circuit board 200; and the third one of the pins 122 is a power-input pin for providing power to the infrared receiver 120 from the printed circuit board 200.

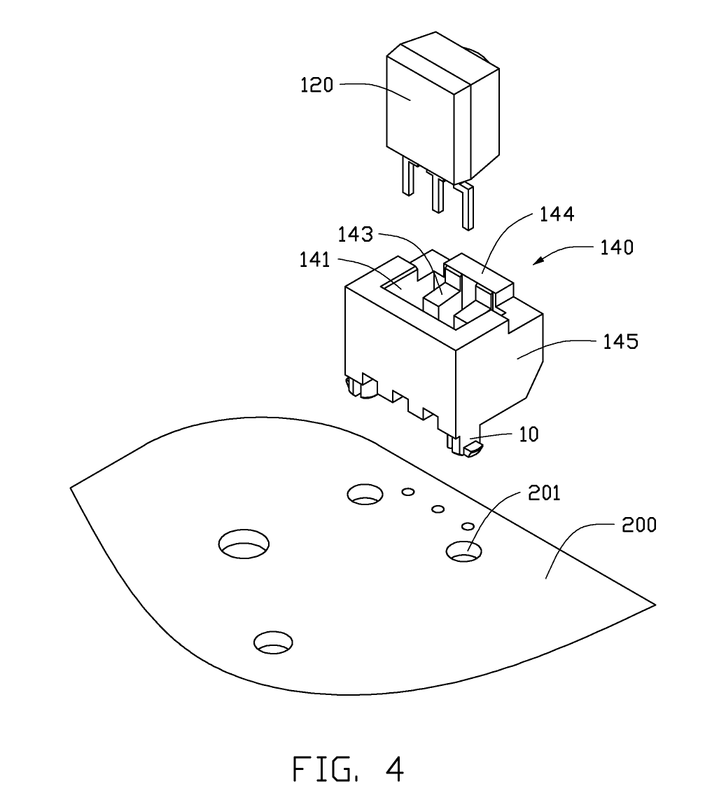

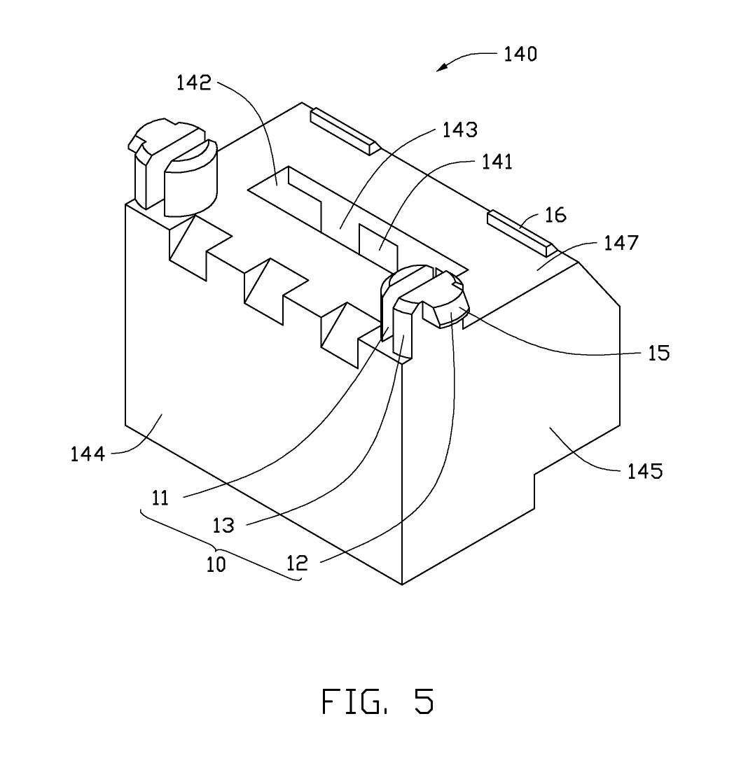

Referring also to FIGS. 4-5, the supporting seat 140 has a cubic configuration. The supporting seat 140 includes a pair of first sidewalls 144, a pair of second sidewalls 145, and a bottom wall 147. The first sidewalls 144, the second sidewalls 145, and the bottom wall 147 cooperatively form a receiving space 141. The bottom wall 147 defines a slot 142 therein. The slot 142 is communicated with the receiving space 141. In this embodiment, two ribs 143 are disposed in the receiving space 141 and spaced from each other. The ribs 143 span the receiving space 141 in such a manner that the ribs 143 are connected with the first sidewalls 144 and spaced from the second sidewalls 145. In other embodiments, there can be only one rib 143 or more than two ribs 143 disposed in the receiving space 141.

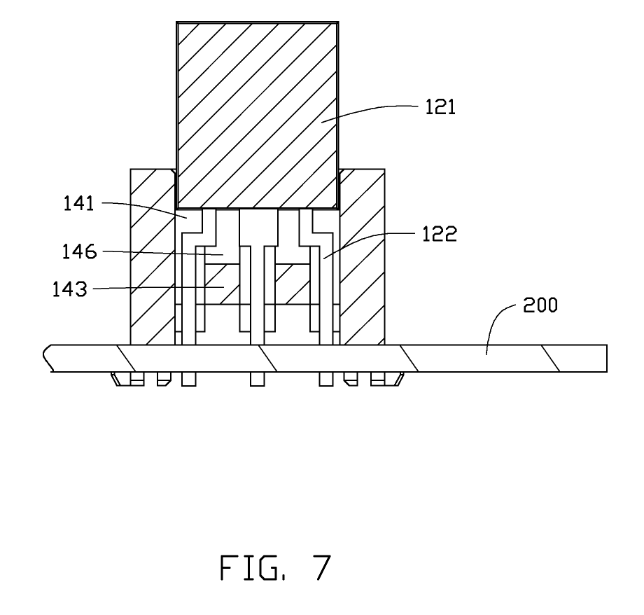

Referring also to FIGS. 6-7, the ribs 143 each define a notch 146 in a substantially central portion of a top thereof, for avoiding interfering with the pins 122 of the infrared receiver 120 (see FIG. 7). A bottom surface of the head 121 of the infrared receiver 120 contacts top surfaces of the ribs 143 so that the ribs 143 support the head 121. The pins 122 do not contact the ribs 143, and pass through the receiving space 141 and the slot 142 of the supporting seat 140, thereby electrically connecting with the printed circuit board 200.

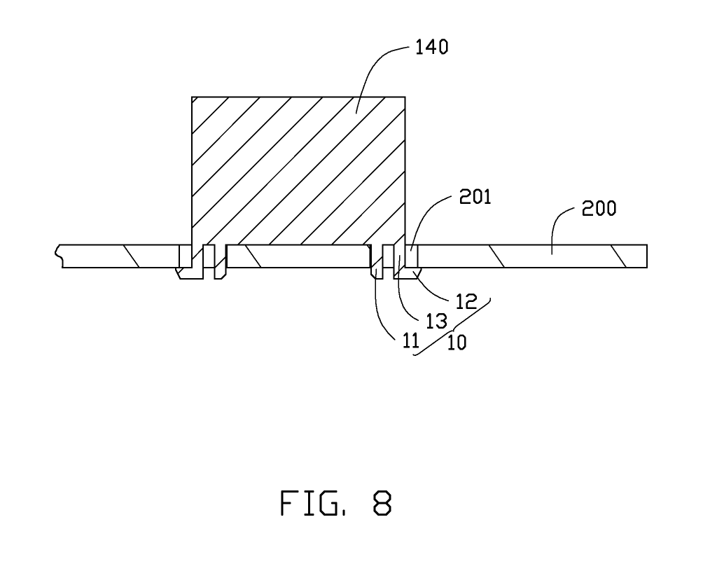

Referring to FIGS. 4-5 again, the bottom wall 147 of the supporting seat 140 forms two hooks 10 and two blocks 16 on a bottom surface thereof. The hooks 10 are located at two corners of a side of the bottom wall 147, respectively. The blocks 16 are located at an opposite side of the bottom wall 147, and are spaced from each other. Each of the blocks 16 has a right trapezoid cross section. Each of the hooks 10 includes a first elastic segment 11 and a second elastic segment 13 spaced from the first elastic segment 11. The second elastic segment 13 forms a latching portion 12 extending perpendicularly and outwardly from a bottom end thereof along a direction away from the first elastic segment 11. The latching portion 12 expands upwardly from the bottom end of the second elastic segment 13 to thereby form an inclined outer surface 15. Referring also to FIG. 8, the supporting seat 140 is pressed downwards to force the second elastic segments 13 to move inwards under guidance of the inclined outer surfaces 15 of the latching portions 12, whereby the second elastic segments 13 are able to pass through a pair of holes 201 defined in the printed circuit board 200. When the latching portions 12 extend beyond a bottom of the printed circuit board 200, the second elastic segments 13 rebound to their original states and are locked beneath the printed circuit board 200 to prevent the supporting seat 140 from escaping from the printed circuit board 200. At the same time, the blocks 16 abut an outer edge of the printed circuit board 200 to prevent the supporting seat 140 from rotating with respect to the printed circuit board 200 (see FIG. 6).

The supporting seat 140 supports and protects the infrared receiver 120, so that the infrared receiver 120 avoids being influenced by external adverse factors such as an external force. The supporting seat 140 is firmly secured on the printed circuit board 200 with the help of the hooks 10 and the blocks 16.

It is understood that the quantities of the hooks 10 and the blocks 16 can be changed according to actual needs. For example, there can be only one hook 10, or more than two hooks 10; and there can be only one block 16, or more than two blocks 16.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An infrared receiving device adapted for mounting on a printed circuit board, the infrared receiving device comprising:
an infrared receiver; and
a supporting seat configured to be mounted on the printed circuit board, the infrared receiver attached to the supporting seat with the supporting seat supporting and protecting the infrared receiver.

2. The infrared receiving device of claim 1, wherein the supporting seat comprises a bottom wall and at least a hook extending downwardly from the bottom wall, the at least a hook configured to be locked beneath the printed circuit board to prevent the supporting seat from escaping from the printed circuit board.

3. The infrared receiving device of claim 1, wherein the supporting seat further comprises at least a block extending downwardly from the bottom wall, the at least a block configured to abut an outer edge of the printed circuit board to prevent the supporting seat from rotating with respect to the printed circuit board.

4. The infrared receiving device of claim 1, wherein the infrared receiver comprises a head and a plurality of pins extending downwardly from the head, the pins extending through the supporting seat and configured to be electrically connected with the printed circuit board, a bottom portion of the head being embedded in the supporting seat.

5. The infrared receiving device of claim 4, further comprising at least a rib in the supporting seat, wherein the bottom portion of the head of the infrared receiver is supported by the at least a rib.

6. The infrared receiving device of claim 5, wherein the supporting seat further comprises a pair of first sidewalls and a pair of second sidewalls, the first sidewalls, the second sidewalls, and the bottom wall cooperatively forming a receiving space, the at least a rib spanning the receiving space in such a manner that the at least a rib is connected with the first sidewalls and is spaced from the second sidewalls.

7. The infrared receiving device of claim 6, wherein the bottom wall of the supporting seat defines a slot communicated with the receiving space, the pins of the infrared receiver pass through the receiving space and the slot, and thereby are capable of electrically connecting with the printed circuit board.

8. The infrared receiving device of claim 5, wherein the at least a rib defines a notch in a substantially central portion of a top thereof, and the pins of the infrared receiver pass through the notch.

9. An electronic device comprising:
a main body comprising a printed circuit board, an infrared receiver mounted on the printed circuit board, and a supporting seat mounted on the printed circuit board, the supporting seat holding the infrared receiver to support and protect the infrared receiver;
a flip cover pivotably attached to the main body; and
a display screen embedded in the flip cover.

10. The electronic device of claim 9, wherein the supporting seat of the main body comprises a bottom wall and at least a hook extending downwardly from the bottom wall, the at least a hook being locked beneath the printed circuit board to prevent the supporting seat from escaping from the printed circuit board.

11. The electronic device of claim 9, wherein the supporting seat of the main body further comprises at least a block extending downwardly from the bottom wall, the at least a block abutting an outer edge of the printed circuit board to prevent the supporting seat from rotating with respect to the printed circuit board.

12. The electronic device of claim 9, wherein the infrared receiver of the main body comprises a head and a plurality of pins extending downwardly from the head, the pins extending through the supporting seat and being electrically connected with the printed circuit board, a bottom portion of the head being embedded in the supporting seat.

13. The electronic device of claim 12, further comprising at least a rib in the supporting seat of the main body, wherein the bottom portion of the head of the infrared receiver is supported by the at least a rib.

14. The electronic device of claim 13, wherein the supporting seat of the main body further comprises a pair of first sidewalls and a pair of second sidewalls, the first sidewalls, the second sidewalls, and the bottom wall cooperatively forming a receiving space, the at least a rib spanning the receiving space in such a manner that the at least a rib is connected with the first sidewalls and is spaced from the second sidewalls.

15. The electronic device of claim 14, wherein the bottom wall of the supporting seat of the main body defines a slot communicated with the receiving space, the pins of the infrared receiver pass through the receiving space and the slot, and thereby are capable of electrically connecting with the printed circuit board.

16. The electronic device of claim 13, wherein the at least a rib defines a notch in a substantially central portion of a top thereof, and the pins of the infrared receiver pass through the notch.

17. An electronic device comprising:
a main body comprising a housing, a printed circuit board, an infrared receiver mounted on the printed circuit board, and a supporting seat mounted on the printed circuit board, the printed circuit board, the infrared receiver, and the supporting seat being received in the housing, the infrared receiver comprising a head and a plurality of pins extending from the head, the supporting seat holding and supporting the head of the infrared receiver, the housing defining an opening in a front side thereof to expose the head of the infrared receiver;
a flip cover pivotably attached to a rear side of the main body; and
a display screen embedded in the flip cover.

18. The electronic device of claim 17, wherein the supporting seat of the main body comprises a bottom wall and at least a hook extending downwardly from the bottom wall, the at least a hook being locked beneath the printed circuit board to prevent the supporting seat from escaping from the printed circuit board.

19. The electronic device of claim 17, wherein the supporting seat of the main body further comprises at least a block extending downwardly from the bottom wall, the at least a block abutting an outer edge of the printed circuit board to prevent the supporting seat from rotating with respect to the printed circuit board.

20. The electronic device of claim 17, further comprising at least a rib in the supporting seat, wherein the pins of the infrared receiver extend through the supporting seat and are electrically connected with the printed circuit board, a bottom portion of the head being embedded in the supporting seat, the bottom portion of the head of the infrared receiver being supported by the at least a rib.
